(19) United States
(12) Patent Application Publication
(10) Pub. No.: US 2008/0091054 A1
(43) Pub. Date: Apr. 17, 2008

(54) Method of synthesizing air-stable zero-valent iron nanoparticles at room temperature and applications

(76) Inventors: Hee-Chul Choi, Gwangju (KR); Abul Bashar Mohammad Giasuddin, Gwangju (KR); Sushil Raj Kanel, Gwangju (KR)

Correspondence Address: HARNESS, DICKEY & PIERCE, P.L.C., P.O. BOX 8910, RESTON, VA, 20195, US

(21) Appl. No.: 11/889,896

(22) Filed: Aug. 17, 2007

(30) Foreign Application Priority Data
Oct. 17, 2006 (KR) 2006-0101079

(51) Int. Cl. A62D 3/38; B22F 9/20

(52) U.S. Cl. 588/320; 75/354; 977/811; 977/903; 977/777

(57) ABSTRACT

A method of synthesizing air-stable nano-scale zero-valent iron (NZVI) particles at room temperature is provided. Also, a method of treating environmental pollutants using nano-scale zero-valent iron synthesized by the above method is provided.

According to the method, air-dried NZVI is very effective in removing pollutants such as arsenic, and the method is simple, cost-effective, environmentally friendly, and can stabilize the NZVI in air for more than 10 months.

### CROSS-REFERENCE TO RELATED APPLICATION

This application claims the benefit of Korean Patent Application No. 10-2006-0101079, filed on 17 Oct., 2006, the disclosure of which is hereby incorporated herein by reference in its entirety.

### BACKGROUND OF THE PRESENT INVENTION

1. Field of the Present Invention

The present invention relates to a method of synthesizing air-stable zero-valent nanoparticles at room temperature, and more particularly, a method of manufacturing nano-scale zero-valent iron (NZVI) having an outer thin oxide layer, and a method for treating environmental pollutants using the NZVI manufactured thereby.

2. Description of the Related Art

Environmental scientists and technicians are very interested in nano-scale iron particles because they remove environmental pollutants and can be applied in various fields. Since a NZVI particle synthesized by a conventional method is oxidized as soon as it comes into contact with air, maintenance of synthesized zero-valent iron is a critical challenge. Since NZVI is also oxidized in water, the reactivity of these novel particles is reduced when used in water purification. The conventional method of controlling oxidation during drying is known to be expensive and complicated. Thus, a novel method of drying synthesized NZVI having high reactivity and a zero-valent state that is cost-effective and simple may open new doors to NZVI users in the treatment of environmental pollutants.

In the purification of environmental pollutants, application of nano-technology is regarded as new and upcoming technology. Over the last few years, the application of nano-technology has shown great potential to provide cost-efficient solutions to solve some environmental problems due to its fascinating removal ability. Among all nanoparticles used in the treatment of environmental pollutants, NZVI has attracted the most attention from those skilled in the art (environmental technicians and scientists) because of its wide applicability and high removal efficiency. NZVI is known to be very effective at the transformation and detoxification of organic contaminants and heavy metals such as TCE (1, 2, 3, 4), PCB (5), chromium, lead (6, 7) and metalloid arsenic (III and V; 8, 9), and general environmental pollutants such as nitrate (10, 11), herbicide (12), PAH (13), TCA and PCA (14), chloroform (CF), nitrobenzene (NB), nitrotoluene (NT), dinitrobenzene (DNB), dinitrotoluene (15), and methane chloride (16).

Though many other methods have been used to synthesize nano-scale iron particles, a method of using iron nanoparticles reduced by borohydride to treat environmental pollutants is best known. The critical characteristic of NZVI that enables it to more effectively react with more pollutants is a zero-valent state. The main technical problem encountered in the treatment of such materials is the high air sensitivity of NZVI. When exposed to air, NZVI is rapidly oxidized and loses its high reactivity. Many techniques have been developed to suppress oxidation and protect NZVI during drying after synthesis, such as use of an anaerobic chamber, lyophillization and vacuum drying techniques. Unfortunately, all of these methods are expensive, complicated, and generate obstacles in various applications of NZVI for removing environmental pollutants.

In the present invention, the inventor firstly discloses a method of drying NZVI synthesized in vitro in air at room temperature, in which the NZVI was maintained in a zero-valent state using some simple temperature control techniques during synthesis. The NZVI dried at room temperature turned out to be in the range of 10 to 100 nm in size, and exhibited a clear zero-peak in X-RD and XPS. A very thin oxide layer (1 to 2 nm) covering core iron was obtained as a TEM image. Furthermore, it was found that the efficiency in removing arsenic of the NZVI dried at room temperature was 3 orders higher than that of ZVI in micro-scale (9).

Despite the multiple applications of NZVI, several challenges to proper use of this novel material still remain. Most problems arise in the step after synthesis when the NZVI is used in dry conditions. Due to its high air sensitivity, the newly synthesized NZVI needs to be protected from oxidation in the air. Gedanken et al. (17) disclose air-stable zero-valent iron nanoparticles sonochemically synthesized in some carbon media or polymeric media. Sonochemically synthesized iron nanoparticles rarely react with pollutants and generate toxic by-products because they use Fe(CO)₅ as a source material. Thus, they are not encouraged in the treatment of environmental pollutants. In general, NZVI reduced with borohydride reportedly reacts very successfully with target pollutants. However, after the NZVI is synthesized from aqueous iron salt reduced with borohydride, another procedure of protecting and drying the NZVI from oxidation was performed. For example, Zhang used a ferric salt requiring an equivalent amount of borohydride solution, washed the NZVI with acetone, and then dried it in an anaerobic chamber (1). Choi et al. used the same procedure as Zhang, but used lyophillization for drying (8). Lowry et al. used an aqueous iron salt mixed with methanol reduced with a small amount of aqueous borohydride solution, and dried the iron particles by heating them in a vacuum at a temperature of 100° C. (2). In consideration of these conventional methods, environmental scientists and technicians have been focusing on a great deal of attention on a method of drying NZVI that is environmentally friendly, cost-effective and stabilizes NZVI in air for long time.

To solve all of the above problems, the present invention first provides a simple method of synthesizing air-stable NZVI, which is highly efficient and effective at removing various toxic pollutants in water such as arsenic.

### SUMMARY OF THE PRESENT INVENTION

The present invention is directed to a simple, cost-effective and environmental friendly method of manufacturing air-stable NZVI dried at room temperature.

The present invention is also directed to an environmental remediation method using NZVI, which has improved reactivity for removing environmental pollutants such as arsenic, manufactured by the above method.

According to an aspect of the present invention, a method of manufacturing a NZVI particle having an outer oxide layer is provided. The method includes the steps of: a) dissolving Fe₂SO₄.7H₂O in an aqueous solution with ethanol; b) dropping a NaBH₄ aqueous solution in the resulting solution and mixing it; c) washing iron nanoparticles synthesized according to steps a) and b) with ethanol; d) drying the iron nanoparticles in air; and e) pulverizing the dried iron nanoparticles.

Step a) may use an aqueous ethanol solution instead of pure water (H₂O), in which case ethanol serves to prevent oxidation of NZVI particles during the reaction. In the present invention, Fe₂SO₄.7H₂O may be dissolved in a 20 to 40% ethanol solution. Within this range of concentration, the dissolution of Fe₂SO₄.7H₂O and oxidation of iron particles may be effectively prevented.

In step b), the dropping rate of the NaBH₄ aqueous solution may be important, because fast injection may cause aggregation of NZVI precipitate, and slow injection may cause oxidation of nanoparticles formed sequentially. The NaBH₄ aqueous solution may be dropped at 3 to 7 ml/min. Within this range of rate, the aggregation of NZVI precipitate and oxidation of nanoparticles may be effectively prevented.

In step b), mixing the solution may be performed using a propeller more powerful than a conventional magnetic stirrer, which results in an increase in reaction rate and prevention of aggregation of the precipitate. The resulting solution may be mixed by a revolving propeller at 300 to 700 rpm. Within this range, reactant mixture and reaction efficiencies may be improved.

In step c), all water remaining on the surface of the iron nanoparticles may be replaced with ethanol. Thereby, the surface of the NZVI may be effectively prevented from direct contact with air.

In step d), the iron nanoparticles may be exposed to air at room temperature for 4 to 8 hours to completely evaporate ethanol. Thereby, a thin oxide layer may be effectively formed on an outer shell of the NZVI according to the evaporation of ethanol. The outer thin layer may be formed of an oxide of Fe⁰, such as Fe₃O₄, to a thickness of approximately 1 to 2 nm.

In step e), the temperature may be maintained at 15 to 25° C. during pulverization. Within this range of temperature, ignition of the dried NZVI may be effectively prevented.

According to another aspect of the present invention, a method of breaking down environmental pollutants including treatment with nano-scale zero-valent iron (NZVI) particles having an outer oxide layer manufactured according to the present invention is provided.

The environmental pollutants may be any pollutants that can be removed or treated by NZVI, but preferably trichloroethylene (TCE), tetrachloroethylene (PCE) or arsenic (As). The treatment may be performed by directly injecting the NZVI into contaminated soil or groundwater according to a convention method, or using a permeable reactive barrier (PRB).

NZVIs are regarded as the most prominent iron nanoparticles reacted to remove water pollutants for in-situ as well as ex-situ water purification. However, since NZVI is easily oxidized in air, the NZVI synthesized in vitro has to be maintained in zero-valent state after drying. It is very important to maintain NZVI's high reactivity until reaction with pollutants. A conventional method of maintaining NZVI in the zero-valent state is very expensive and complicated. For this reason, the inventor has developed an easier method of drying the synthesized NZVI which ensures nano-scale and zero-valent NZVI for at least 10 months. The synthesized NZVI may have a size in the range of 10 to 100 nm, as measured using an atomic force microscope (AFM) and a transmission electron microscope (TEM). Furthermore, a TEM image shows a very thin oxide layer disposed on the outside of a Fe⁰ core. The zero-valent state of the NZVI synthesized in vitro is identified using x-ray diffraction (X-RD) and an x-ray photoelectron spectrometer (XPS). The high reactivity of NZVI was proven by a test using arsenic, a toxic element contained in groundwater.

The arsenic removal ability of NZVI is 3 orders higher than that of micro-scaled ZVI. Thus, the NZVI dried in air at room temperature of the present invention has great reaction potential to remove pollutants in groundwater such as arsenic.

In the present invention, the NZVI is synthesized by a borohydride reduction method. In an exemplary embodiment of the present invention, the NZVI is synthesized by dropping an aqueous borohydride solution. Conventionally, both FeCl₃.6H₂O and FeSO₄.7H₂O were used. During the reaction with the borohydride solution, these two different aqueous solution salts show significant and stoichiometrical differences in reaction. In an aqueous solution, borohydride reacts more rapidly with FeSO₄.7H₂O than FeCl₃.6H₂O, which is important because it tends to be less oxidized in the solution obtained after synthesis and may save time. Another significant difference is that FeSO₄.7H₂O may save a large amount of money since it requires less borohydride than FeCl₃.6H₂O. In consideration of these facts, FeSO₄.7H₂O is chosen. Instead of pure H₂O, 30% ethanol is used for the aqueous iron salt, which serves to prevent oxidation during the reaction. Here, since ethanol having C═C bonding not found in methanol tends to protect iron salt from oxidation well, ethanol is chosen in the present invention. In addition, ethanol is environmental friendly and less toxic than methanol. To prevent aggregation of nanoparticles as much possible, a propeller is used instead of a conventional magnetic stirrer.

### BRIEF DESCRIPTION OF THE DRAWINGS

The above and other objects, advantages and features of the present invention will become apparent by describing certain exemplary embodiments thereof with reference to the attached drawings, in which:

FIG. 1 is an atomic force microscopic (AFM) image of nano-scale zero-valent iron (NZVI) dried when exposed to air at room temperature;

FIG. 2 is an X-ray diffraction (X-RD) pattern of NZVI dried at room temperature;

FIG. 3 is an X-ray photoemission spectroscopic (XPS) spectrum with respect to NZVI dried at room temperature;

FIG. 4 is a transmission electron microscopic (TEM) image of NZVI dried at room temperature;

FIG. 5 is a graph illustrating arsenic (III) removal capacity of NZVI dried at room temperature; and

FIG. 6 is a graph illustrating trichloroethylene (TCE) removal efficiency of NZVI dried at room temperature.

### DETAILED DESCRIPTION OF THE PRESENT INVENTION

The present invention will now be described more fully hereinafter with reference to the accompanying drawings, in which exemplary embodiments of the present invention are shown.

### Exemplary Embodiment 1

### Manufacture of Air-Stable Nano-Scale Zero-Valent Iron (NZVI) Dried at Room Temperature

To manufacture air-stable NZVI dried at room temperature, 20 g of Fe₂SO₄.7H₂O was added to one liter of 30% ethanol solution and completely dissolved by stirring for 5 minutes at 500 rpm. Next, 2 g of NaBH₄ was added to 50 ml of de-ionized water. Then, aqueous NaBH₄ was added drop-by-drop to aqueous iron salt at 5 ml/min and vigorously mixed by a propeller revolving at 500 rpm. Here, control of the dropping rate is very important because quick addition may cause aggregation of NZVI precipitates. In contrast, very slow addition may cause oxidation of nanoparticles which are formed sequentially. In addition, ethanol may provide a protection layer for each iron nanoparticle. Right after complete addition of NaBH₄, the reaction was stopped, and then a beaker was set on a magnet to rapidly separate newly synthesized NZVI in a supernatant. When all nanoparticles were precipitated on the bottom of the beaker, one minute later, the supernatant was removed, and then the precipitated particles were washed with 100% ethanol three times to remove all by-product salts and replace all water remaining on the surface of the nanoparticles with alcohol. Then, the wet nanoparticles were centrifuged for 5 minutes at 3000 rpm. The supernatant was removed, and then solid iron particles were exposed to air at room temperature for 6 hours to completely evaporate the alcohol. While the dried NZVI was pulverized with spatula, the temperature was maintained at 20° C. because of the dried NZVI's ignition characteristic. The final yield of the dried NZVI was 70% (3.5 gm).

### Exemplary Embodiment 2

### Test for Identifying Size of Manufactured NZVI

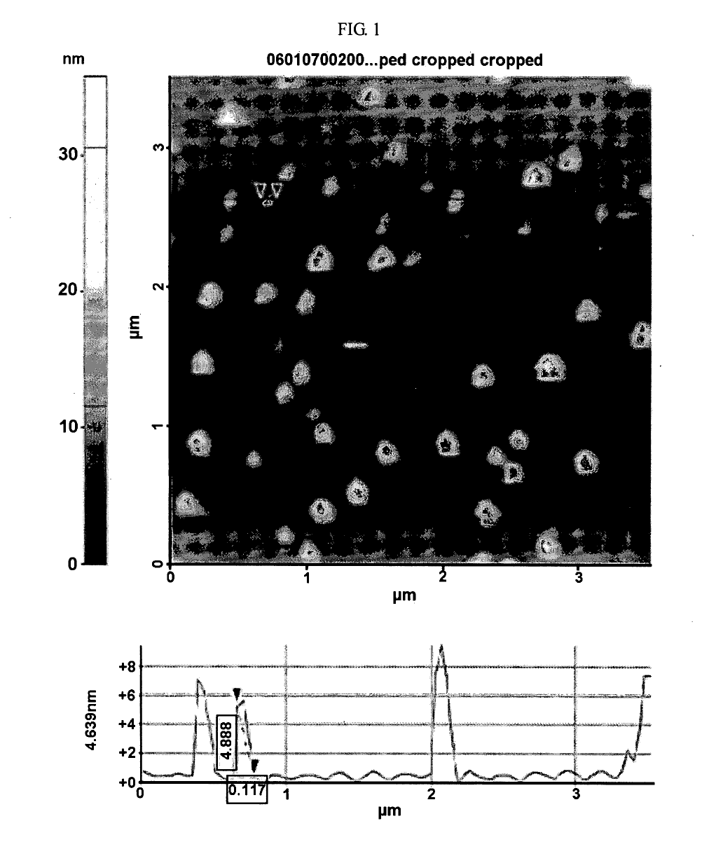

To identify the size of the NZVI synthesized in Exemplary Embodiment 1, a picture of the NZVI was taken using AFM (XEI 100, PSIA. Co.). FIG. 1 is an atomic force microscopic (AFM) image of the dried NZVI when exposed to air at room temperature. It may be seen from FIG. 1 that the size of the NZVI is in the range of 10 to 100 nm, and 50% of its size is smaller than 50 nm. The peak under FIG. 1 represents the surface state of a particle, in which the peak height indicates the height of a particle.

### Exemplary Embodiment 3

### Test for Identifying Zero-Valent State of Manufactured NZVI

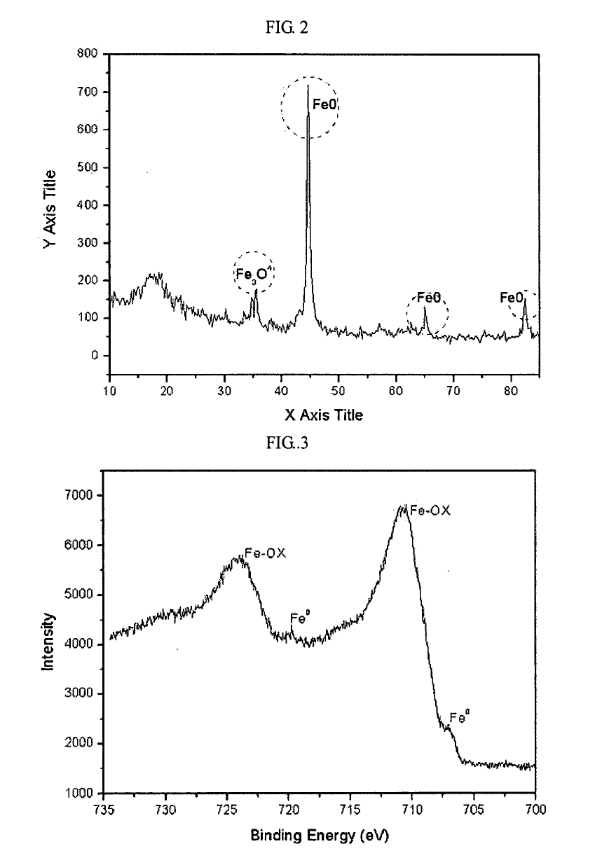

To check the zero-valent state of the NZVI dried at room temperature, its X-RD pattern was observed using an X-ray diffractometer (Miniflex diffractometer generator, tension=40 kV, at room temperature). FIG. 2 is an X-RD pattern of the NZVI dried at room temperature. As can be seen in FIG. 2, even though a little oxide peak was seen, the very clear Fe⁰ peak was also seen. The small oxide peak is shown because of a thin oxide film on the surface of the NZVI.

### Exemplary Embodiment 4

### Test for Identifying Outer Oxide Layer of Manufactured NZVI

Research using XPS (Multilab200, VG) provided more concrete evidence of Fe⁰ having a Fe³⁺ layer in its outer shell. Peaks reached bonding energy level 707 (eV) and 710.9 to 711.8 (eV) (see FIG. 3). FIG. 3 is an x-ray photoemission spectroscopic (XPS) spectrum of the NZVI dried at room temperature. In FIG. 3, Fe—OX represents iron oxide such as Fe³⁺. The XPS research depends on take-off angles of the particles and the XPS has sensitivities in 3 to 5 nm outer shells of the particles, so that the peak for Fe⁰ shows that an outer shell is less than several nanometers in thickness (18, 19).

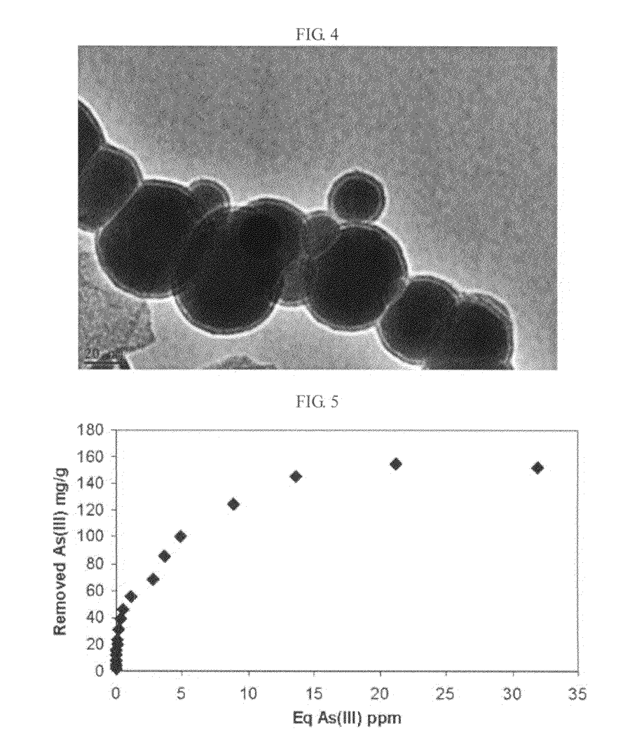

In addition, the NZVI was photographed with a magnification of 80,000 to 100,000 using TEM (JEOL JEM 2100). FIG. 4 is a TEM image of the NZVI dried at room temperature. The TEM image of FIG. 4 more clearly shows a thin layer (<1.5 nm), which was identified as oxide by X-RD. A deep black core shell (>95%) was identified as pure iron metal by X-RD.

### Exemplary Embodiment 5

### Reactivity Test of Air-Dried NZVI

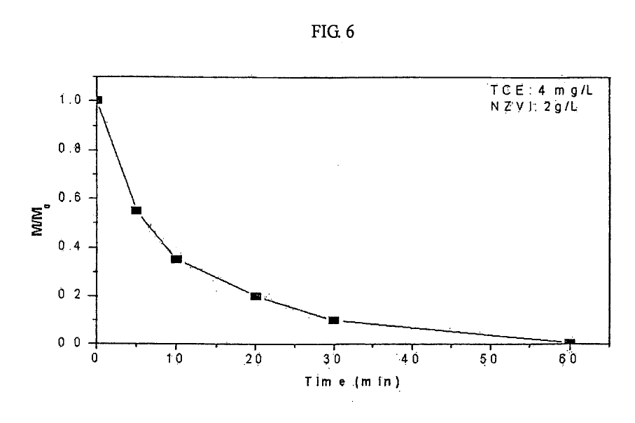

In this embodiment, removal efficiencies of arsenic (III) and trichloroethylene (TCE) were tested using NZVI dried at room temperature according to a conventional method. To investigate the reactivity of this air-dried NZVI, the inventor performed batch experiments. FIG. 5 is a graph illustrating arsenic (III) removal capacity of NZVI dried at room temperature. FIG. 5 shows that the air-dried NZVI has a maximum arsenic (III) removal capacity of 160 mg/g. In contrast, literature shows that another NZVI dried by a different method has an arsenic (III) removal capacity of merely 3.5 mg/g (9). FIG. 6 shows TCE removal efficiency of NZVI dried at room temperature. It may be noted that the air-dried NZVI according to the present invention exhibits excellent efficiency in removing TCE.

As described above, the present invention provides a simple method for obtaining NZVI dried at room temperature, and describes characteristics of NZVI using AFM, X-RD, XPS and TEM to prove its nano-size and zero-valent state. Also, the inventor tested the efficiency of such NZVI to identify reactivity with a target pollutant, for example, arsenic (III). The air-dried NZVI turned out to be very effective in removing pollutants such as arsenic. Thus, the method of drying the NZVI at room temperature according to the present invention is simple, cost-effective, environmentally-friendly, and stabilizes the NZVI in air for more than 10 months.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

### REFERENCES

1. Wang, C.-B.; Zbang, W.-X Environ. Sci. Technol.; 1997, 31(7); 2154-2156.
2. Liu, Y.; Majetich, S. A.; Titon. R. D.; Sholl, D. S.; Lowry, G. V. Environ. Sci. Technol.; 2005; 39(5); 1338-1345.
3. Liu, Y.; Choi, H. Dionsiou, D.; Lowry, G. V. Chem. Meter.; 2005; 17(21); 5315-5322.
4. Dror, I; Baram, D.; Berkowitz, B. Environ. Sci. Technol.; 2005; 39(5); 1283-1290.
5. Lowry, G. V.; Johnson, K. M. Environ. Sci. Technol.; 2004; 38(19); 5208-5216.
6. Ponder, S. M. Darab, J. G. Mallouk, T. Environ. Sci. Technol.; 2000; 34(12); 2564-2569.
7. N. S. Feng et al, Journal of Zhejiang University Science, 2005
8. Kanel, S. R.; Manning. B., Charlet, L.; Choi, H. Environ. Sci. Technol.; 2005-39(5); 1291-1298.
9. Kanel. S. R.; Greneche, J.-M.; Choi. H. Environ. Sci. Technol.; 2006; 40(6); 2045-2050.
10. Gordon C. C. Yang and Hsaio-Lan Lee Water Research, Volume 39, Issue 5, March 2005, Pages 884-894
11. Seunghee Choe, Sang-Hyun Lee, Yoon-Young Chang, Kyung-Yub Hwang and Jeehyeong Khim Chemosphere, Volume 42, Issue 4, February 200, Pages 367-372
12. Joo, S. H.; Feitz, A. J.; Waite, T. D. Environ, Sci. Technol.; 2004; 38(7); 2242-2247.
13. Ming-Chin Chang and Hung-Yee Shu, Wen-Pin Hsieh, Min-Chao Wang, Journal of Air & Waste Management, August, 2005.
14. Song, H.; Carraway; E. B., Environ, Sci. Technol.; 2005; 39(16); 6237-6245.
15. Seunghee Choe, Yoon-Young Chang, Kyung-Yub Hwang and Jeehyeong Khim Chemospehere, Volume 41, Issue 8, October 2000, Pages 1307-1311.
16. Hsing-Lung Lien and Wei-xian Zhang J. Envir. Engrg. 125, 1042 (1999).
17. Sergei I. Nikitetinko, Yuri Koltypin, Oleg Palchik, Israel Felner, Xiao N and Aharon Gedanken (2001). Angene Chem. Int. Ed. 2001, 40, No 23.
18. Nurmi. J. T.; Tratnyek. P. G.; Sarathy. V. Baer, D. F. Amonette, J. E.; Pecher, K.; Wang, C., Linehan. J. C,; Matson, D. W.; Penn, R. L.; Driessen, M. D. Environ, Sci. Technol.; 2005; 39(5); 1221-1230.
19. Shigeru Suzuki, Katsuyuki Yanagihara, Kichinesuke Hirokawa. Surface and Interface Analysis, 2000; 30(1), 372-376.

What is claimed is:

1. A method of manufacturing a nano-scale zero-valent iron (NZVI) particle having an outer oxide layer, comprising the steps of:
a) dissolving Fe₂SO₄.7H₂O in an aqueous solution with ethanol;
b) dropping NaBH₄ aqueous solution into the resulting solution and mixing it;
c) washing iron nanoparticles synthesized according to steps a) and b) with ethanol;
d) drying the iron nanoparticles in air; and
e) pulverizing the dried iron nanoparticles.

2. The method according to claim 1, wherein step a) is performed by dissolving FeSO₄.7H₂O in a 20 to 40% ethanol solution.

3. The method according to claim 1, wherein step b) is performed by dropping the NaBH₄ aqueous solution at 3 to 7 ml/min.

4. The method according to claim 1, wherein step b) is performed by mixing the resulting solution with a propeller revolving at 300 to 700 rpm.

5. The method according to claim 1, wherein step c) is performed by replacing all water remaining on the surface of the iron nanoparticles with ethanol.

6. The method according to claim 1, wherein, in step d), the iron nanoparticles are exposed to air at room temperature for 4 to 8 hrs to completely evaporate ethanol.

7. The method according to claim 1, wherein, in step e), the temperature is maintained at 15 to 25° C. during pulverization.

8. A method of breaking down environmental pollutants, the method comprising the step of:
treating the environmental pollutants with nano-scale zero-valent iron (NZVI) particles having an outer oxide layer manufactured according to any one of claims 1 to 7.

9. The method according to claim 8, wherein the environmental pollutants comprise trichloroethylene (TCE), tetrachloroethylene (PCE), or arsenic (As).
